(19) United States
(12) Patent Application Publication
(10) Pub. No.: US 2002/0131057 A1
(43) Pub. Date: Sep. 19, 2002

(54) Spatially multiplexed rainbow display

(76) Inventors: Michael V. Lee, Santa George, UT (US); John N. Hait, San Diego, CA (US)

Correspondence Address: Gary L. Eastman, Esq, All Optical Networks, Inc., 9707 Waples Street, San Diego, CA, 92121, US

(21) Appl. No.: 09/810,887

(22) Filed: Mar. 16, 2001

(51) Int. Cl. G01B 11/14

(52) U.S. Cl. 356/614

(57) ABSTRACT

An apparatus and method are provided to spatially multiplex information into a rainbow spectrum by filtering out certain frequencies or colors of the spectrum. The frequencies that are filtered or blocked out may depend on a value of a system input such as a level indicator, temperature gauge, pressure indicator, and the like. The spectrum, absent the filtered out frequencies, is sequentially focused into a single composite beam for transport through an optical path or fiber. Upon arrival to a destination, the composite beam is spatially separated into the original rainbow spectrum and projected onto a display. A viewer may subsequently view the spectrum and any dark areas within the spectrum associated with filtered or blocked frequencies and may, therefore, monitor a remotely located system.

### BACKGROUND

1. The Field of the Invention

The present invention relates to the frequency multiplexing, transmission, display and use of physical position information sent via frequency-multiplexed light beams.

2. Background

Frequency multiplexing has traditionally involved the production of multiple carrier frequencies modulated with information to be retrieved at the receiver by separation and demodulation of independent channels. Whether the technique is used with radio, microwave, or light, the process is basically the same. Except in the case where specific information has been assigned to specific channel positions, such as television video, chromatic information and audio, the channel positions within the spectrum have no special significance. A television station can just as easily broadcast on one channel as another.

Despite the commonly accepted beauty of a rainbow or prismatic dispersion, little practical value has been found in them. No method or apparatus provides a utility for the separation of colors as a means of direct transfer of information. No remote transmission of information has been found, nor any display using the same light for both transmission and ultimate projection for viewing. Meanwhile, neither is the phenomenon used for direct frequency multiplexing of information.

### BRIEF SUMMARY AND OBJECTS OF THE INVENTION

In view of the foregoing, it is a primary object of the present invention to provide an apparatus and method of multiplexing spatial information. It is another object of the invention to provide a visual display of spatial multiplexed information. It is another object of the invention to provide color-coded spatial information. It is yet another object of the invention is to provide spatial information that can be transmitted and received without the negative environmental effects that affect electronic methods.

The foregoing objects and benefits of the present invention will become clearer through an examination of the drawings, description of the drawings, description of the preferred embodiments, and claims that follow.

When information is transmitted via light, the same information can be transmitted using any color (e.g. blue light, red, etc.). The visible range is capable of containing many independent channels.

Particular bands of frequencies within a spectrum have physical relationships not hitherto exploited. Unexploited physical relationships include the “physical” positioning of energy from individual channels at locations within a dispersed spectrum, with respect to each other. Such physical positioning may result when the energy in the spectrum is directed through a diffraction system such as a prism or diffraction grating.

Using a prism with the visible band of light as an example, red is always positioned next to yellow, then green, then blue, then violet. The prism never performs otherwise. It cannot be physically confused. The colors always maintain these spatial positions. Moreover, the rainbow of color remains substantially contiguous if the light-source spectrum is substantially contiguous. Many light sources such as an incandescent bulb, for example, produce a multitude of spectral lines, close enough together to produce a spectrum considered substantially contiguous.

The present invention exploits the physical relationship that frequency-multiplexed information assumes as a result of separation by a diffraction system (e.g. prism, diffraction grating, etc.). At an information transmission site, a dispersed (spatially separated) spectrum illuminates a masking area. A movable mask may be placed in or moved about in the masking area to block (i.e. absorb, reflect, divert, etc.) or pass through (i.e. transmit) energy of various frequencies. Blocking depends upon the physical position of the mask relative to the physical positions of the various colors (i.e. frequency channels) within the dispersively illuminated masking area.

A transmitter may essentially be a mechanically-controlled (e.g. pneumatic, hydraulic, electric, and the like) optical bandpass filter. The “filter” passes a band of frequencies controlled by the position of the mask. The mask may be positive (selectively transmitting) or negative (i.e. selectively blocking).

Unmasked light may be gathered together using lenses, prisms, mirrors or other optical elements. Light may be directed or focused into a composite beam for transmission, usually by directing the composite beam into an optical fiber.

As a mask is moved by some actuating mechanism (e.g. sensor, gauge, thermometer, and the like), the position of the mask is spatially and frequency-multiplexed into the composite beam. Each frequency channel (color) is illuminated (or darkened) in sequence as a mask is moved along the spatially distributed colors of the spectrum. As a result, a relationship may be established between a position of a mask and particular frequencies. Whether energized or not, frequency-multiplexing spatial information may be embodied in the composite beam, yielding positional or spatial multiplexing.

A remote destination device (receiver) may be as simple as a diffraction mechanism such as another prism or diffraction grating along with a display screen, which the light is projected onto or through for viewing. The spatially multiplexed composite beam received from the optical fiber is directed through this remote display prism to produce a remote illuminated area on the display screen.

A prism reorganizes and repositions (distributes) available bands of energy into a spectral display. Colors have the same relative positions as within the illuminated masking area of the transmitter, and thus the frequency-multiplexed information is displayed as spatially-related information within a displayed spectrum. Displayed position, color, or both may indicate the position of the mask back at the transmitter.

For example, the mask may be a simple thin bar or indicator needle that blocks only a small band within the illuminating spectrum at the masking area. The remote display may include an incomplete rainbow spectrum lacking certain colors. A dark line will exist at any channel position blocked out by spectral masking by a needle or other mask located anywhere between the display and the transmitter where the light has been dispersed. As the needle is moved relative to the dispersed spectrum in the masking area, different parts of the spectrum are filtered out (blocked) by the mask. In the display, a dark line in the spectrum (an absence of those corresponding colors) moves along the rainbow to indicate directly a position of the mask (needle).

One unique quality of an apparatus in accordance with the present invention may be manifest by a comparison of the organization of energy within both the illuminated masking area and the remote illuminated area and within the composite beam transmitting between the two illuminated areas. In the two illuminated areas, the energy content is organized spatially into rainbow spectra. However, in the composite beam, no spatial organization exists. While some of the color channels may be energized and other color channels may not, the energy essentially occupies the same space within the optical fiber as it travels through the fiber. Only when the energy is spatially reorganized by a display prism or diffraction grating are the spatial relationships of the various frequency channels revealed. Thus, the frequency multiplexing of spatial information that takes place in the transmitter is (demultiplexed and displayed at the receiver.

Likewise, the position of the needle mask is indicated by the position of adjacent energized and de-energized channels, which have been displayed by prisms and/or diffraction gratings, and the like. This is due to the fact that the receiver organizes the available energy in the same spatial relationships as received from the transmitter, whereas, in the composite beam, the spatial information of the needle mask is indistinguishable from the rest of the beam.

For example, one application in accordance with the invention may include a thermometer, whereby a dark line within the rainbow spectrum may indicate a temperature. As the temperature changes, the position of a masking needle may change relative to various channels within an illuminating spectrum at a transmitter, turning adjacent channels (colors) progressively on or off Consequently, the dark line within a displayed spectrum may move relative to the displayed spectrum, indicating the temperature. When the temperature changes in a certain direction, the dark line may move toward the violet end of the displayed spectrum. Conversely, as the temperature moves in an opposite direction, the dark line may move toward the red end of the displayed spectrum (or vice versa).

Likewise, other useful applications may be implemented in accordance with the invention. For example, spatially-multiplexed composite beams can be routed from transmitter to receiver using optical fibers or any other structure for directing beams from one place to another. Consequently, the information from a temperature sensor on an aircraft engine may be routed through an airframe to a cockpit using optical fibers. There, the position of a thermometer needle may be displayed directly as a dark line in a rainbow spectrum using energy that has traveled directly from an engine. However, unlike traditional methods, the process only requires the use of a light-weight optical fiber, rather than a bundle of copper wires.

Unlike electro mechanical remote sensing methods currently used in automobiles and aircraft, the present invention may not require calibration other than aligning the position of the displayed spectrum with any numbers or marks on the display screen. Whereas temperature and other environmental factors can affect the calibration of electrical systems by changing the resistance in transmission wires, the present invention is immune to such changes. A fiber optic cable may be curved or bent, but the spectrum, while it may vary in intensity, will still be visible. Moreover, bending of an optic fiber will not change the spectrum of a transmitted beam and thus will not alter the displayed position of the needle or within the spectrum. In instances where weight is critical, applications of the present invention may be constructed of lightweight materials such as plastic, as opposed to heavy copper wire and servo motors used in conventional remote sensing and display equipment.

Another characteristic of the present invention is that a variety of mask shapes may be used to produce a variety of displays. The mask may also be constructed with a slot that allows only a narrow band to pass, or a solid mask with its edge acting as an indicating position. This may be implemented so that the bandpass is made wider or narrower depending on the position of the mask edge.

Accordingly, with proper selection of an appropriate mask shape, spatially multiplexed information from the composite beam may also be viewed directly as color-coded information without the use of a remote prism. Also, in certain embodiments, multiple moving masks may be used in distinct portions of the spectrum to transmit information from multiple sources.

As a practical matter, a variety of mechanical arrangements for accomplishing spatial multiplexing, including the implementation of colored filters as a mask or movable light sources that replace the mask, may be implemented. Although the present disclosure uses optical terminology and components, the present invention may operate using any substantially contiguous band of the electromagnetic spectrum and is not limited to visible light (except when direct viewing is required).

In accordance with the invention, the method or process of spatially multiplexing information at the transmitter may be summarized in the following steps: (1) providing multifrequency electromagnetic energy spatially separated in frequency as a substantially contiguous spectrum illuminating a masking area; (2) providing a movable mask or masks positioned and oriented to mask at least one portion of the masking area; (3) combining non-masked electromagnetic energy from the masking area into at least one composite beam; (4) moving one of the movable masks to various positions along the masking area, changing the composite frequency content of the composite beam (depending upon the position of the movable mask), thereby multiplexing spatial information about the movable mask into the composite beam; and (5) using an optical waveguide to carry the composite beam to a remote receiver (optional) to extract the spatial information of the composite beam.

Accordingly, extraction of spatial information at the receiver requires directing the composite beam to at least one remote device having a structure for separating the composite beam into a remote illuminated area, having different positions for different frequencies of the multifrequency electromagnetic energy. Thus, the receiver provides the spatial information relative to the remote illuminated area by illuminating the different positions as energy is available from the composite beam, which is controlled by the movable mask.

Production of a visible display can include these additional steps: First, to use visible light as said electromagnetic energy, and second, to position and orient said remote illuminated area so that it can be viewed, providing a remote display of said spatial information.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of an apparatus and method in accordance with the invention of a rainbow display;

FIG. 2 is a schematic of one embodiment of a rainbow display apparatus in accordance with the invention;

FIG. 3 is a diagram of one embodiment of a spectrum display in accordance with the invention;

FIGS. 4a-4c are diagrams of several embodiments of spectrum masks in accordance with the invention;

FIG. 5 is a diagram of one embodiment of a spectrum masking device using a bimetallic spring;

FIG. 6 is a schematic diagram of a fluid level indicator demonstrating one possible implementation of the rainbow display apparatus in accordance with the invention;

FIG. 7 is a schematic diagram of a temperature gauge demonstrating one possible implementation of the rainbow display;

FIG. 8 is a schematic diagram of a pressure indicator demonstrating one possible implementation of the rainbow display;

FIG. 9 is a schematic block diagram of one embodiment of a rainbow display implementing a beam deflector to deflect a single frequency light beam;

FIG. 10 is a schematic diagram of one embodiment of a broad spectrum light separator implemented in conjunction with a movable channel receiver configured to receive a single frequency of light;

FIG. 11 is a diagram of a rotatable light separator for possible implementation in a rainbow display apparatus;

FIG. 12 is a diagram of one embodiment of a pivotable mirror configured to direct determined light frequencies into a waveguide;

FIG. 13 is a diagram of a pivoting mirror configured to direct determined light frequencies into an optic fiber or other reception channel;

FIG. 14 is a diagram or a movable array of frequency-distinct light sources configured to pass a single light frequency through an opening in a mask for transmission to a display;

FIG. 15 is a schematic diagram of one embodiment of a rainbow display apparatus wherein the broad spectrum light source is located near the receiver or display;

FIG. 16 is a schematic diagram of a display configured to display only one frequency of visible light; and

FIG. 17 is a diagram of several possible embodiments for colored light or rainbow spectrum displays in accordance with the invention;

### DETAILED DESCRIPTION OF THE PREFERRED EMBODIMENTS

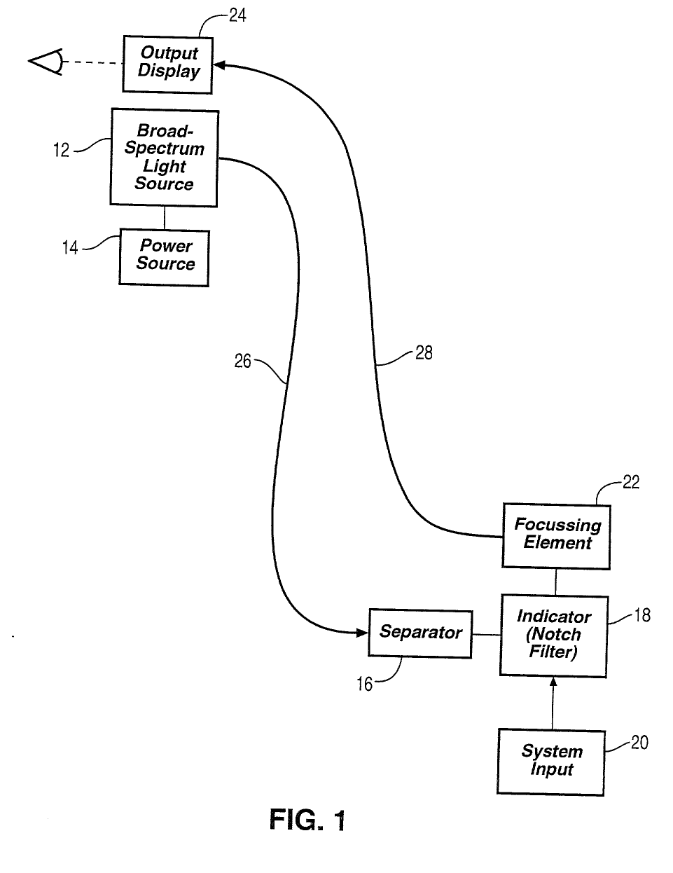

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 17, is not intended to limit the scope of the invention. The scope of the invention is as broad as claimed herein. The illustrations are merely representative of certain, presently preferred embodiments of the invention. Those presently preferred embodiments of the invention will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only to be exemplary, and simply illustrate several presently preferred embodiments that are consistent with the invention as claimed.

Referring to FIG. 1, a block diagram for a rainbow display apparatus in accordance with the invention may include a broad spectrum light source 12 energized by a power source 14. That is, a power source 14 may energize a light source 12 configured to generate visible light in one composite beam 26 containing the full continuum of colors contained in visible white light (red through violet). The composite beam 26 is passed to a beam separator 16, wherein the individual light frequencies (colors) are spatially separated into a rainbow spectrum. The rainbow spectrum is sequentially passed through a filter 18 wherein certain frequencies or colors are filtered (i.e. blocked) out as controlled by some system input 20.

Subsequently, the individual rainbow spectrum frequencies, absent the filtered or blocked out frequencies, are recombined by a focusing element 22 into a composite beam 28, or a beam 28 wherein all remaining light frequencies are combined or mixed. The composited beam 28 is then passed to an output display 24 wherein the composite beam 28 is spatially separated and displayed as a rainbow of colors, absent the colors or frequencies removed in the filtering process. Thus, the output display 24 may display a dark area where the frequencies were blocked out by the filter 18 controlled by the system input 20. Such a system may be advantageous to monitor a remote event or process and may eliminate the need for many parts used in typical gauges and displays.

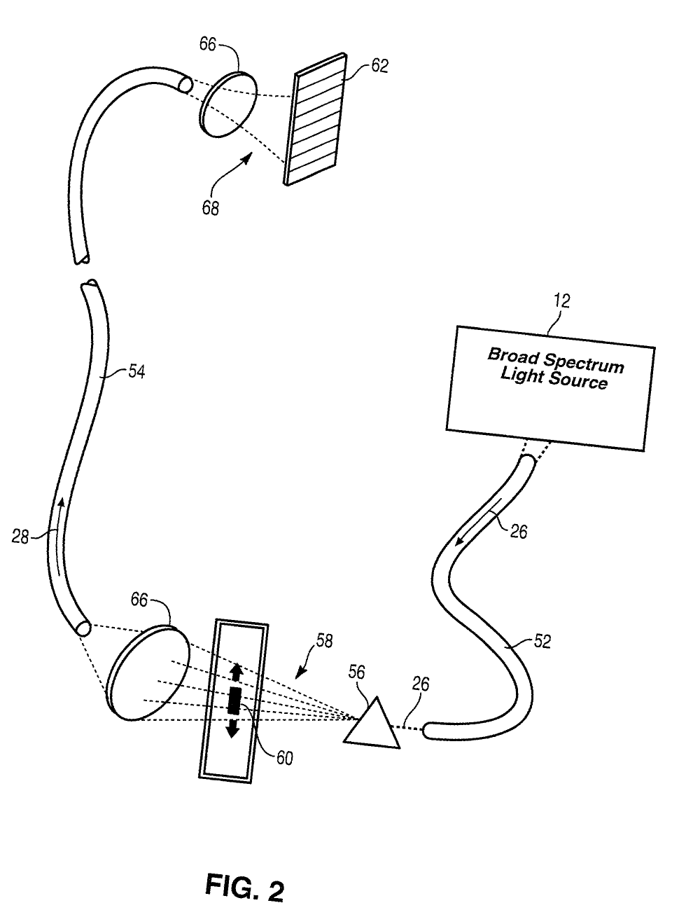

Referring to FIG. 2, one embodiment of a rainbow display apparatus may comprise a broad spectrum light source 12, which transmits a composite beam 26 through a channel 52 or optic fiber 52. Upon leaving the channel 52, the beam 26 may be spatially separated by a prism 56 or diffraction grating 56 into a rainbow spectrum 58. Subsequently, a mask 60 or filter 60 actuated by an input system blocks a portion of the spectrum 58. The remaining spectrum 59 may then be recombined into a single composite beam 28 by a focusing element 64, which may comprise a plurality of prisms, lenses, and the like. The composite beam 28 may be transmitted through a channel 54 or optic fiber 54 until it exits the channel 54 and is spatially separated by a separating element 66 or lens 66 and projected onto a display 62. A dark spot will appear in that portion of the rainbow spectrum 59 that is blocked by the filter 60 or mask 60.

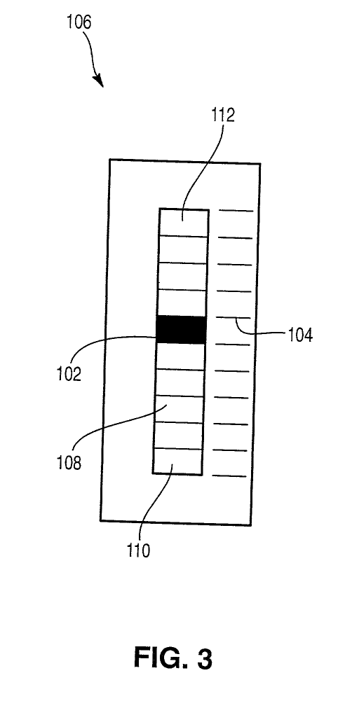

Referring to FIG. 3, one embodiment of a display 106 or viewer 106 may display a spectrum 108 of colors. Such a display 106 or viewer 106 may be used as a gauge or indicator in the cockpit of an airplane or the cabin of an automobile. For example, a rainbow spectrum may contain red at one end 110 and violet at the other end 112. Likewise, any other range of contiguous values of visible colors as contained in white light may be used as the spectrum 108. A dark line 102 or gap 102 may appear corresponding to the frequencies filtered or blocked out by a mask 60. Accordingly, a scale 104 may be calibrated using specific marks on the display 106, which in turn will give meaning or value to the location of the dark line 102 or gap 102. The exact layout or configuration of the display 106 may comprise numerous shapes and forms and need not be limited to the configuration illustrated.

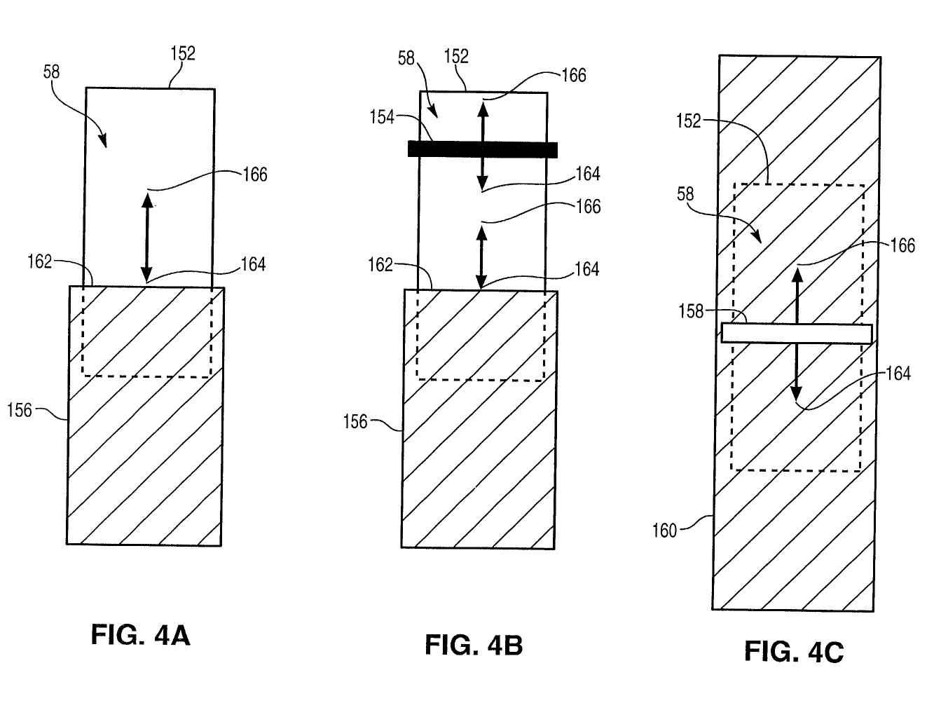

Referring to FIGS. 4A-4C, several alternative mask shapes and configurations are illustrated for use as filters in accordance with the invention. For example, in FIG. 4A, a solid mask 156 may be implemented wherein the mask edge 162 is used to block out portions of the spectrum 58 contained in the mask area 152. The mask edge may be moved in the directions 164, 166, and thus block out differing amounts of the spectrum 58. Accordingly, the viewer would observe a lower (or upper) portion of the spectrum 58 as a dark area on the display 106, as described previously.

Likewise, in another embodiment, a needle mask 154 may be used in conjunction with the aforementioned solid mask 156 as illustrated in FIG. 4A. Consequently, multiple independent sources of information may be multiplexed into the same composite beam 28 (described previously) and shown on a common display 24. For example, the needle mask may move in the directions 164, 166, representing one system input, and the mask 156 may also move in the directions 164, 166, representing another system input.

In yet another embodiment, a mask 160 with a slot 158 may be moved across a masking area 152 in the directions 164, 166 as illustrated in FIG. 4C. As a result, all portions of the spectrum 58 except those exposed by the slot 158 will be blocked or filtered. An embodiment of this configuration may be used to pass a single frequency of light to a display 24 to notify a viewer of some system response or state.

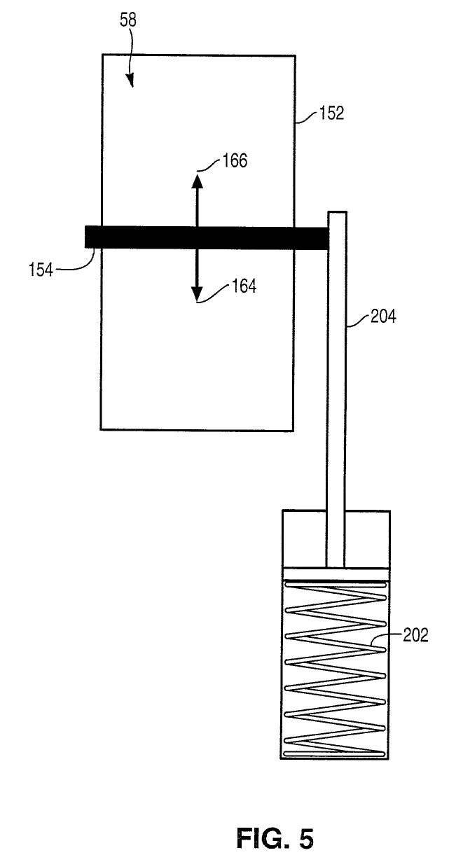

Referring to FIG. 5, an application for use with the present invention may include a bimetallic spring 202, which expands or contracts in response to changes in temperature. The spring may be configured to actuate an arm 204 connected to a needle mask 154, which moves in the directions 164, 166. As described previously, the needle mask 154 moves across the mask area 152, blocking portions of the spectrum 58. Such a mechanism may be implemented in a temperature gauge in accordance with the invention.

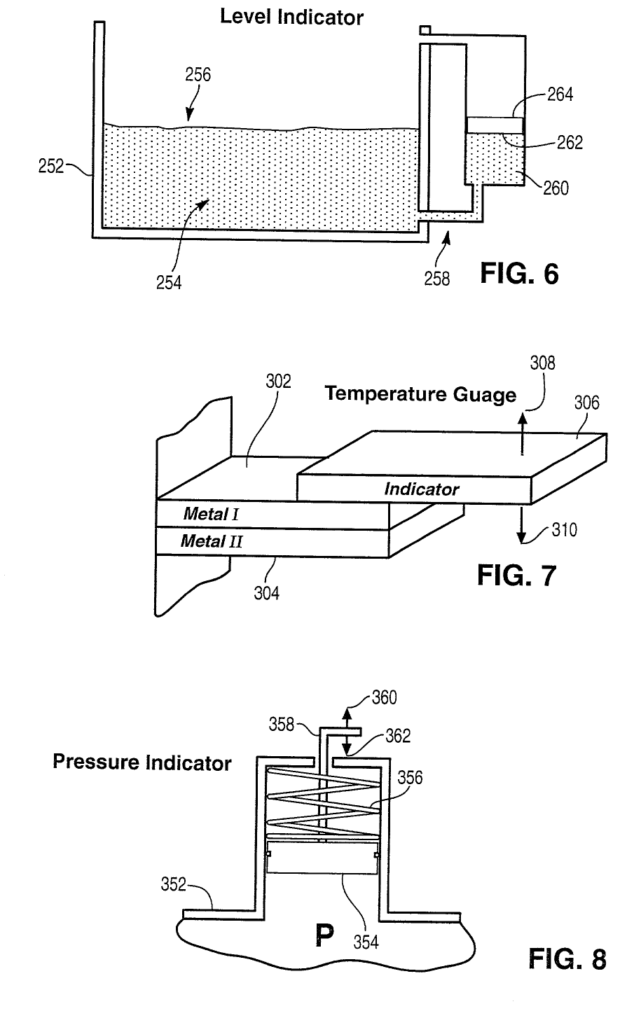

Referring to FIG. 6, an application of the rainbow display apparatus may be implemented in conjunction with a level indicator. As illustrated, a tank 252 may contain a liquid 254 or fluid 254 at a level 256. An adjoining measurement compartment 260 may be connected to the tank 252 by a channel 258 such that the levels 256, 262 are equal. As the level 256 rises or falls, the level 262 will correspondingly rise or fall and move a level indicator 264 or float 264, which may be used to actuate a mask or filter in accordance with the invention.

Referring to FIG. 7, a further application of the rainbow display apparatus may be implemented in conjunction with a temperature gauge. A first metal 302 may be joined to a second metal 304, each of the metals having a different coefficient of thermal expansion. That is, for any increase or decrease in temperature, the first metal 302 will expand by a larger or smaller amount than the second metal 304, causing the joined metals 302, 304 to bend or curve. Consequently, an indicator 306 attached to the joined metals 302, 304 will move in the directions 308, 310. Like the previous examples hereinbefore discussed, the indicator 306 may be implemented to actuate a mask or filter in accordance with the invention of the rainbow display apparatus.

Referring to FIG. 8, yet a further application of the rainbow display apparatus may be used in conjunction with a pressure indicator. A container 352 or receptacle 352 may contain a pressurized gas or liquid that exerts force on a piston 354 or diaphragm 354. The piston 354 or diaphragm 354, in turn, exerts a force compressing a spring 356 actuating an arm 358, which moves in the directions 360, 362. The arm 358 may be used to actuate a mask or filter to be used with the present invention of the rainbow display apparatus.

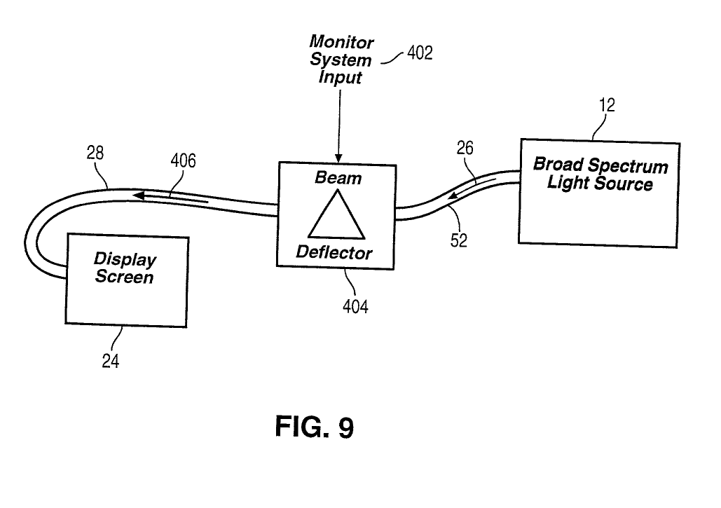

Referring to FIG. 9, one embodiment in accordance with the invention may include a broad spectrum light source 12, which transmits a composite beam 26 through a channel 52, such as an optic fiber 52. A beam deflector 404 receives the beam 26 and separates the composite beam 26 into spatially separate colors or frequencies. Meanwhile, the beam deflector 404 receives an input signal 402 (e.g. electrical or mechanical) and transmits one of the colors or frequencies into the channel 54, depending on the value of the system input 402. Thus, a particular color 406 or frequency 406 will be transmitted for viewing on a display screen 24, depending on some external system input 402. An embodiment of this configuration may be useful when a single color 406 or frequency 406 is desired to monitor the state of some remote system.

For example, the beam deflector may be configured to transmit the color red when a system is in a critical state, yellow for a cautionary state, or green for a favorable state.

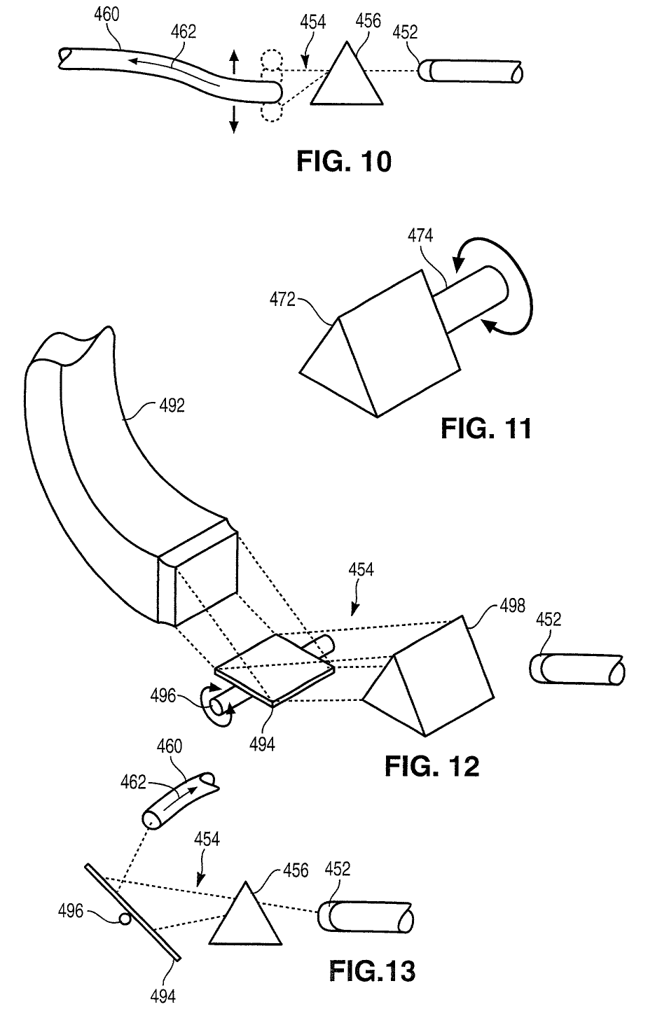

Referring to FIG. 10, one embodiment is illustrated for the beam deflector 404 of FIG. 9, wherein only one color is desired for display. A broad spectrum light source 452 may transmit a composite beam to a light diffractor 456 or beam separator 456, which spatially separates the beam into the rainbow spectrum 454. A channel 460 may be configured to move in directions 464, 466 to receive only a single color 462 or frequency 462 to be transmitted to a display device.

Referring to FIG. 11, one alternative embodiment for the beam deflector 404 of FIG. 9 for use in the present invention may comprise a prism 472 that rotates on a shaft 474. As a result, the angle of deflection of any color or frequency may be controlled by rotating the shaft 474, which may be controlled by some external system input 402.

Referring to FIG. 12, another alternative embodiment for the beam deflector 404 for use in the present invention may comprise a broad spectrum light source 452, which transmits a beam through a prism 498 or beam separator 498 into a rainbow spectrum 454. A mirror 494 may be configured to pivot about a shaft 496 and reflect certain bands of frequencies of the rainbow spectrum 454 into a waveguide 492, depending on the angle of the mirror 494. Thus, the angle of the mirror 494, and therefore, the transmitted bands or frequencies, may be controlled by some external system input 402 as illustrated in FIG. 9.

Referring to FIG. 13, yet another alternative embodiment for a beam deflector 404 may comprise a broad spectrum light source 452, which may transmit a beam through a prism 456 or beam separator 456 into rainbow spectrum 454. A mirror 494 may be configured to pivot about a shaft 496 and deflect a single color 462 or frequency 462 into a channel 460 or optic fiber 460. Similar to the previous examples, the angle of the mirror 494, and thus, the transmitted color 462 or frequency 462, may be controlled by an input 402 from an external system.

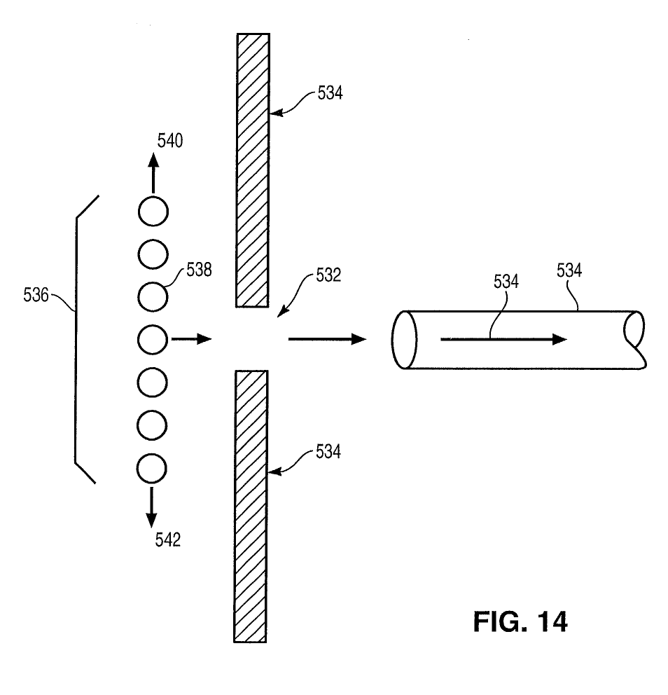

Referring to FIG. 14, another alternative embodiment for transmitting a single color 462 or frequency 462 may comprise a movable array 536 of distinct light sources emitting different colors or frequencies. The array 536 may be positioned behind a mask 534 or filter 534, which may block all light frequencies except a single color 538 or frequency 538, which is allowed to pass through an opening 532 in the mask 534. The array 536 may move in the directions 540, 542, or alternately, the mask 534 and channel 460 may be configured to move with respect to the array 536. Thus, a single color 462 or frequency 462 may be transmitted to a display through a channel 460 or optic fiber 460. Such an arrangement, would allow an arrangement of light sources 536 to be ordered in any desired sequence, and would not limit the ordering to that occurring in the natural rainbow spectrum.

For example, in the natural rainbow spectrum, the lowest visible light frequency starts at red and continues through the colors orange, yellow, green, and the like until the frequency for violet is reached. However, when using an array 536 of light sources, wherein each light source 538 may emit a single color or frequency, the lights 536 may be arranged in any order desired and certain frequencies may be omitted if such frequencies are not used, or rearranged to display colors 538 or frequencies 538 in a selected order. Therefore, this embodiment may provide an increased degree of flexibility to design specific gauges, displays, sensors, thermometers, and the like.

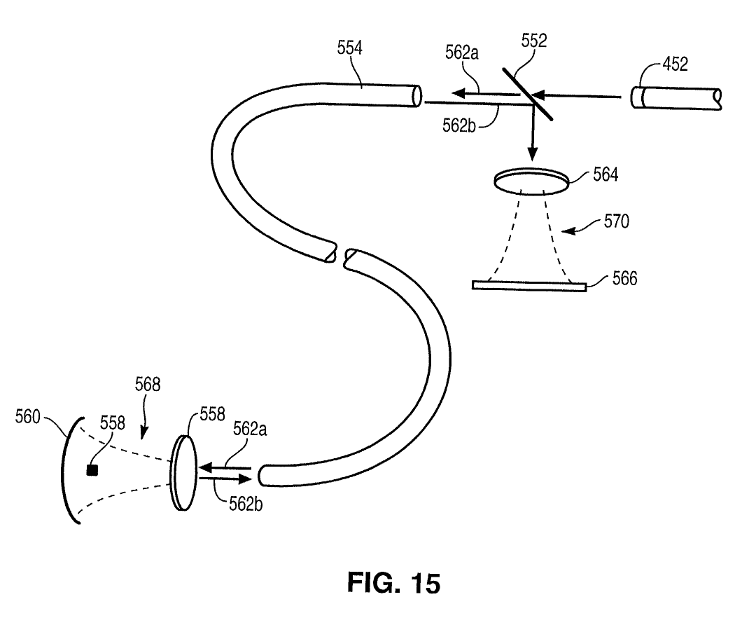

Referring to FIG. 15, sometimes it may be more convenient to have a light source 452 located at the receiving end rather than at the transmitting end of a rainbow display apparatus in accordance with the present invention. FIG. 15 illustrates one embodiment in which a composite multicolored beam is transmitted through a channel 554 or optic fiber 554 wherein the beam is spatially multiplexed, only to return back to the receiving end for display.

Light source 452, which produces broad spectrum light, may be directed by optical apparatus through a beam splitter 552, such as a half-silvered mirror 552, along a path 562a into a channel 554 or an optical fiber 554. The multifrequency light may exit the optical fiber 554 and may be spatially separated by a separator 556, such as a lens 556 or prism 556, and may be projected through a mask area defined by a plane 559 having a needle mask 558. Unmasked light may be reflected from a mirror 560, such as a parabolic mirror 560, back into the lens 556 or prism 556. The remaining colors or frequencies may subsequently be recombined into a composite beam 562b and transmitted back through the optical fiber 554 along a path 562b or light beam 562b. Light beam 562b may be routed by the mirror 552 to a separating element 564, such as a lens 564 or prism 564, and separated into a rainbow spectrum 570 (absent the blocked out frequencies) onto a display 566. Thus, both the light source 452 and the display 566 are positioned at the same end of the transmitting fiber 554.

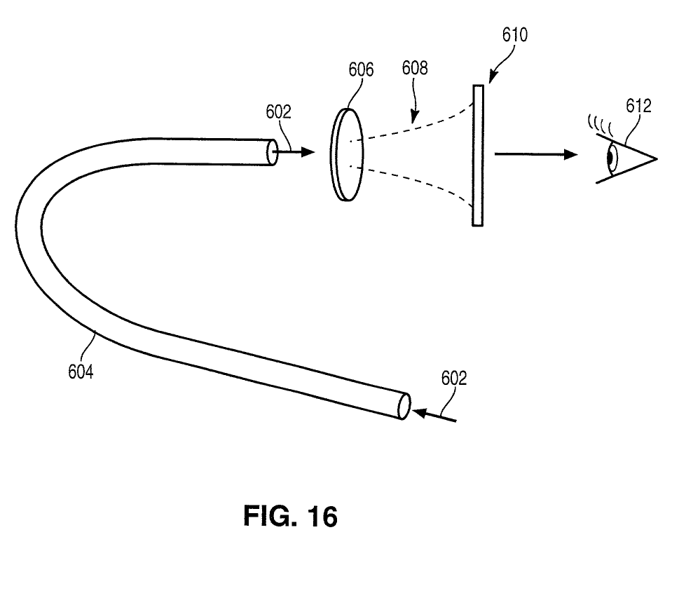

Referring to FIG. 16, an embodiment for a display apparatus that uses only a single color or frequency is illustrated. A single color 602 or frequency 602 may be transmitted through a channel 604 or an optical fiber 604 to a dispersing element 606, such as a lens 606. Such a dispersing element 606 may spread or distribute the single frequency energy 608 over an area and onto a display 610 for viewing by a user 612.

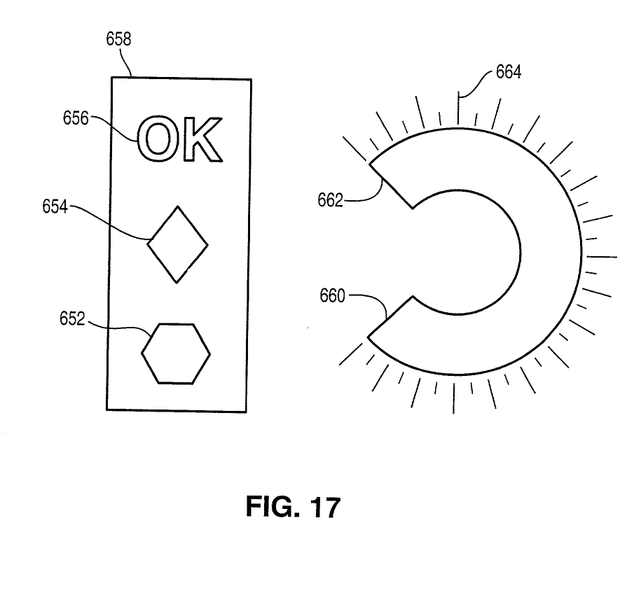

Referring to FIG. 17, lighted symbols or special shaped displays may be implemented to provide particular information to the viewer by properly positioning and orienting various translucent symbols on an opaque background 658. Red light, for example, may be directed to a stop symbol 652. Likewise, yellow light may be directed to a caution symbol 654, and green light to an OK symbol 656. Alternatively, energy from the various parts of the sensor may be routed to new positions within a specially-shaped display. For instance, energy from a remote sensor may be directed into a semicircular shape with violet appearing at an end 660, and continuing through the rainbow spectrum to red at another end 662. A semicircle display 659 may also be calibrated so that a dark line may be interpreted based on a particular scale 664.

From the above discussion, it will be appreciated that the present invention provides a method for multiplexing spatial information by optical means using fewer mechanical parts than typical electrical gauges and sensors. The present invention predominantly relies on moving parts implemented in the transmitting end of the device instead of in the instrumentation of the display. Furthermore, the calibration of gauges may be greatly reduced by use of the present invention because colors or frequencies filtered out by the masking device will be exactly replicated when viewed on a display. The weight and danger inherent in electrical wiring may also be lessened by substituting an optical path, such as an optical fiber, for transmitting information.

The present invention may be applied to various commonly used gauges and sensors such as level indicators, temperature gauges, pressure indicators, and the like. Likewise any system that may be employed to actuate a mask or colored lights may make use of the present invention to transmit information.

Moreover, the present invention uses the colors of the rainbow spectrum to display information, therefor enabling color-coding of information. The present invention may make use of an entire spectrum, filtering out portions of the spectrum thereof, or may route only specified colors or frequencies to transmit information. Likewise, the display may use many colors of the spectrum or simply use a single color to notify a user of the status of some external system.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. An apparatus for displaying an image reflecting a sensed condition, the apparatus comprising:
a light source configured to produce light having a range of frequencies;
an optical path for connecting the light source to a chromatic separator;
the chromatic separator, configured to spatially distribute a light signal from the light source in accordance with the wavelength thereof into a plurality of distinguishable colors;
an indicator configured to select a subset of the spatially distributed light signal in accordance with an input; and
a display operably connected to receive the light signal from the chromatic separator, and to identify the indicated subset.

2. The apparatus of claim 1, further comprising:
a first optical conduit for carrying the light signal from the chromatic separator to the display;
a focusing element positioned between the chromatic separator and the display for re-focusing the light signal into the first optical conduit.

3. The apparatus of claim 1, further comprising a sensed system, having a sensible condition, and positioned with respect to the indicator such that the indicator reflects the sensible condition.

4. The apparatus of claim 3, further comprising a power source, remote from the sensed system, connected to the light source for supplying energy to create the light signal.

5. The apparatus of claim 1, wherein the chromatic separator is selected from the group consisting of a prism, diffraction grating, and a chromatically dispersive element.

6. The apparatus of claim 1, wherein the light source is selected from the group consisting of an incandescent source, solar radiation, gaseous discharge lamp, and a laser, light emitting diode.

7. The apparatus of claim 1, further comprising an optical element positioned proximate the display to enlarge the viewable displayed signal.

8. The apparatus of claim 1, wherein the indicator is selected from the group consisting of a rotatable member, a translatable member, and a pivotable member.

9. The apparatus of claim 8, wherein the indicator effects indication by filtration selected from the group consisting of blocking, redirecting, and transmitting, the light signal selectively.

10. The apparatus of claim 1, wherein the indicator and the chromatic separator are configured to selectively transmit to the display a portion of the light signal reflecting a measured condition of interest.

11. The apparatus of claim 1, further comprising an optical path between the chromatic separator and the display, and wherein the optical path is movable to select the subset.

12. The apparatus of claim 1, wherein the light source provides light in the visible spectrum.

13. The apparatus of claim 1, wherein the light source has a comparatively broad-spectrum.

14. The apparatus of claim 13, wherein the light source produces light of wavelengths in a band having a width of from about 0.1 microns to about 0.35 microns

15. The apparatus of claim 14, wherein the light source produces light in the visible range of the electromagnetic spectrum.

16. The apparatus of claim 13, wherein the light source is incandescent.

17. The apparatus of claim 1, wherein the light source produces light in a plurality of comparatively narrow spectral bands.

18. The apparatus of claim 17, wherein the light source produces light in bands having widths on the order of less than 0.1 microns.

19. The apparatus of claim 18, wherein the light source produces light in the visible spectrum.

20. The apparatus of claim 19, wherein the light source is selected from the group consisting of gaseous discharge tubes, metal vapor lamps, solid lasers, dye lasers, and gas lasers.
